(19) United States
(12) Patent Application Publication
(10) Pub. No.: US 2016/0318174 A1
(43) Pub. Date: Nov. 3, 2016

(54) HANDLE FOR A HAND TOOL

(71) Applicant: Tuo-Jen Chen, Taichung (TW)

(72) Inventor: Tuo-Jen Chen, Taichung (TW)

(21) Appl. No.: 14/698,848

(22) Filed: Apr. 29, 2015

(51) Int. Cl. B25G 1/10

(52) U.S. Cl. CPC B25G 1/102; B25G 1/105

(57) ABSTRACT

A handle of a hand tool includes a handle having a connection portion and a grip portion. The grip portion has two parallel side faces and each of the side faces has a width of X. Two protrusions are formed between the two side faces. Each of the two protrusions has a width of Y, wherein Y≦¾X. The connection portion has a connection position formed at its distal end thereof to which a driving member is connected. The axis of the handle is parallel to the driving member. The connection position has a long axis and a short axis. The length of the long axis Z, wherein Z≦½Y. The handle is easily gripped and save storage space.

### BACKGROUND OF THE INVENTION

1. Fields of the Invention

The present invention relates to a handle for a hand tool, and more particularly, to an elongate handle for a hand tool. The handle is light and provides more grip area.

2. Descriptions of Related Art

The conventional handle 10 for a hand tool generally has a connection portion 11 and a grip portion 12. The axis X1 of the handle 10 is parallel with the driving member 13 which is connected to the connection portion 11. The grip portion 12 is designed for being gripped by the user's hand. The user grips the grip portion 12 and rotates the handle 10 to tighten or loosen an object by the driving member 13.

FIGS. 2 and 3 show that the conventional handle 10 has an anti-slip portion 121 or ridges 122 formed on the grip portion 12 so as to increase friction between the grip portion 12 and the user's hand.

However, the anti-slip portion 121 or the ridges 122 may occupy too much area that is supposed to be held by the user's hand. Therefore, the user cannot firmly hold the grip portion 12 to operate the hand tool.

Besides, the anti-slip portion 121 or the ridges 122 require extra machine to make, and this also increases manufacturing cost.

As shown in FIG. 4, the generally round grip portion 12 may not suitable for some users to hold because the grip portion 12 is much larger than some users' hand. Therefore, the users cannot output sufficient torque to the driving member. 13.

As shown in FIG. 5, the shape of the grip portion 12 and the handle 10 wastes the storage space when being stored

The present invention intends to provide a handle of a hand tool to improve the shortcomings mentioned above.

### SUMMARY OF THE INVENTION

The present invention relates to a handle of a hand tool comprises a handle having a connection portion and a grip portion. The grip portion has two parallel side faces and each of the side faces has a width of X. Two protrusions are formed between the two side faces. Each of the two protrusions has a width of Y, wherein Y≦¾X. The connection portion has a connection position formed at its distal end thereof to which a driving member is connected. The axis of the handle is parallel to the driving member. The connection position has a long axis and a short axis. The length of the long axis Z, wherein Z≦½Y. The handle is easily gripped and save storage space.

Preferably, the grip portion has an anti-slip portion formed thereon so as to increase friction between the handle and a user's hand.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional handle of a hand tool;

FIG. 2 shows another conventional handle of a hand tool;

FIG. 3 shows yet another conventional handle of a hand tool;

FIG. 4 shows that a user's hand grips one of the conventional handles;

FIG. 5 shows that the handles of the hand tools waste storage space;

FIG. 6 is a perspective view to show the handle of the present invention;

FIG. 7 shows an end cross sectional view, taken along ling VII-VII of the handle of the present invention;

FIG. 8 shows that a user's hand grips the grip portion of the handle of the present invention;

FIG. 9 shows that the handles of the present invention are collected side-by-side;

FIG. 10 shows that the grip portion of the handle of the present invention has an anti-slip portion, and

FIG. 11 shows the anti-slip portion of the grip portion of the handle of the present invention.

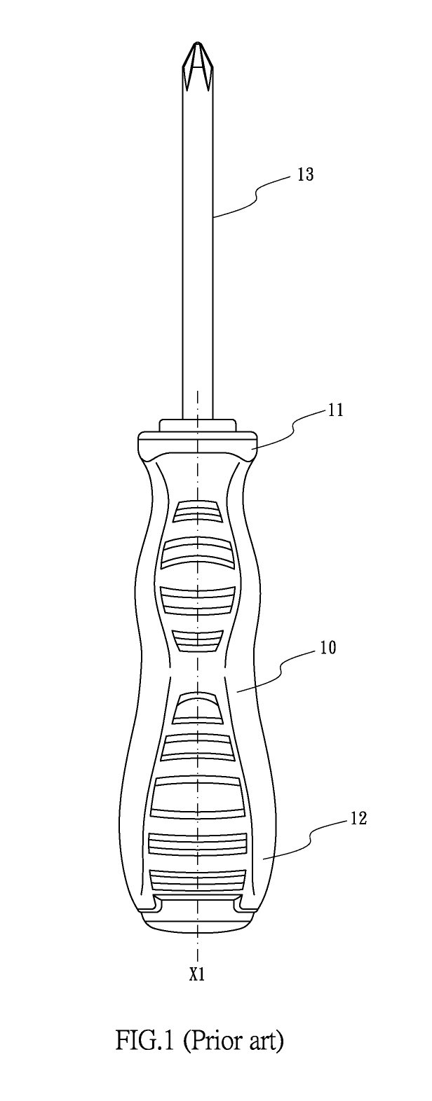

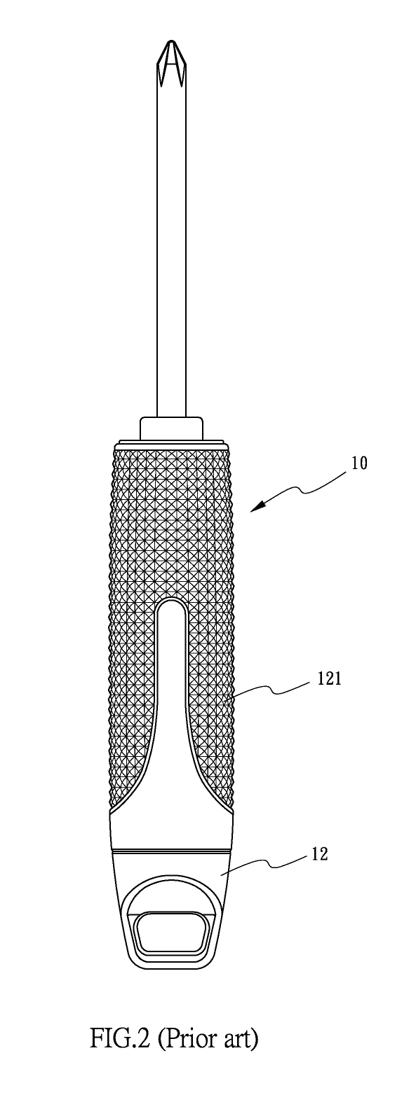

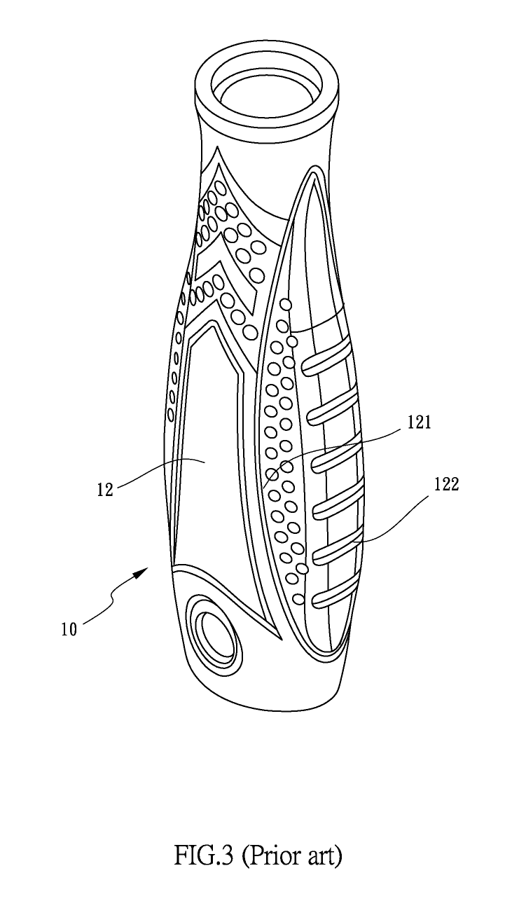

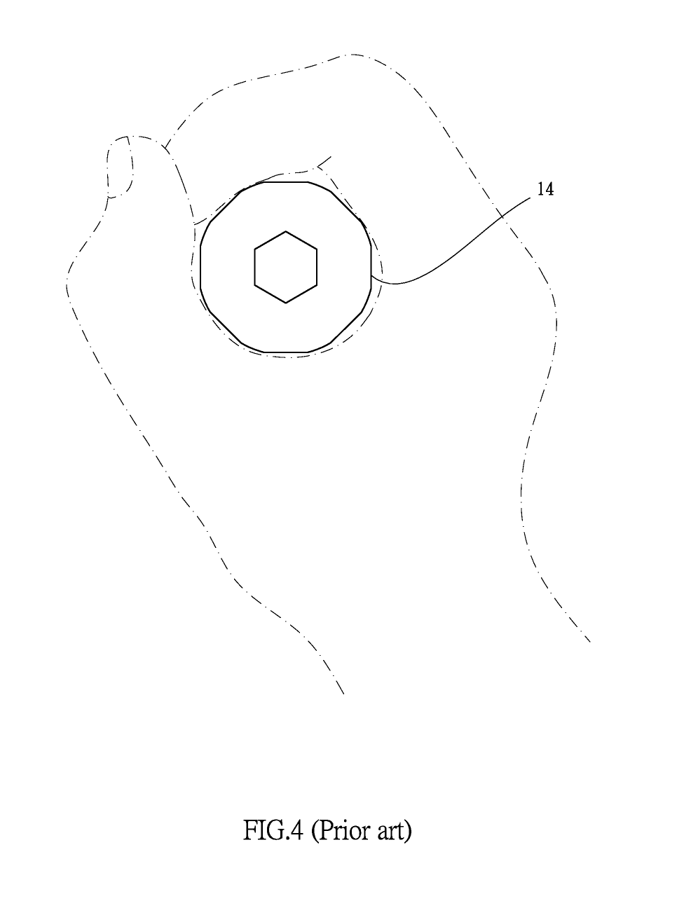

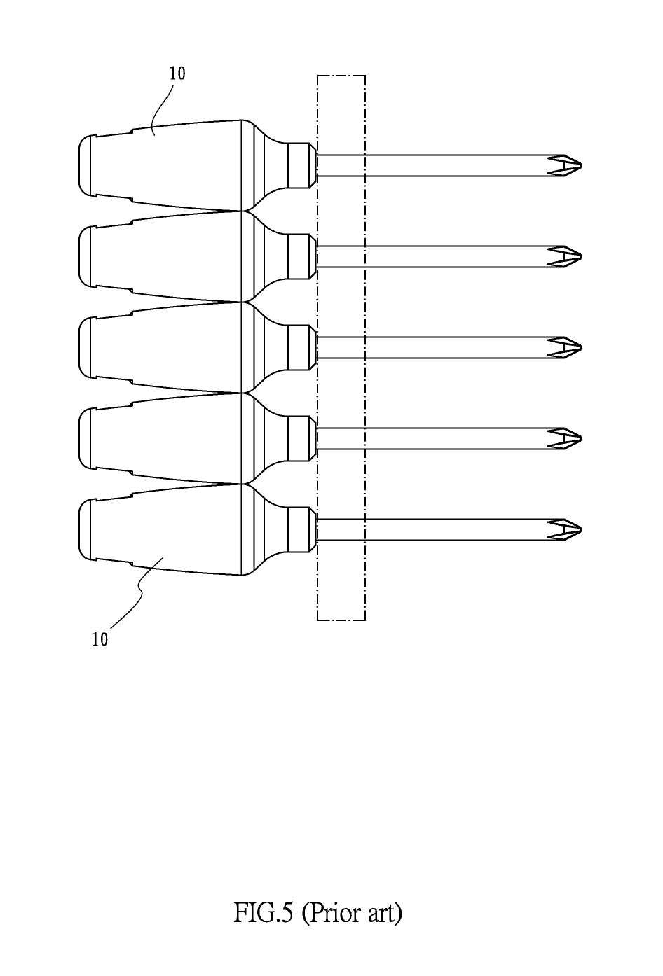

### DETAILED DESCRIPTION OF THE PREFERRED EMBODIMENT

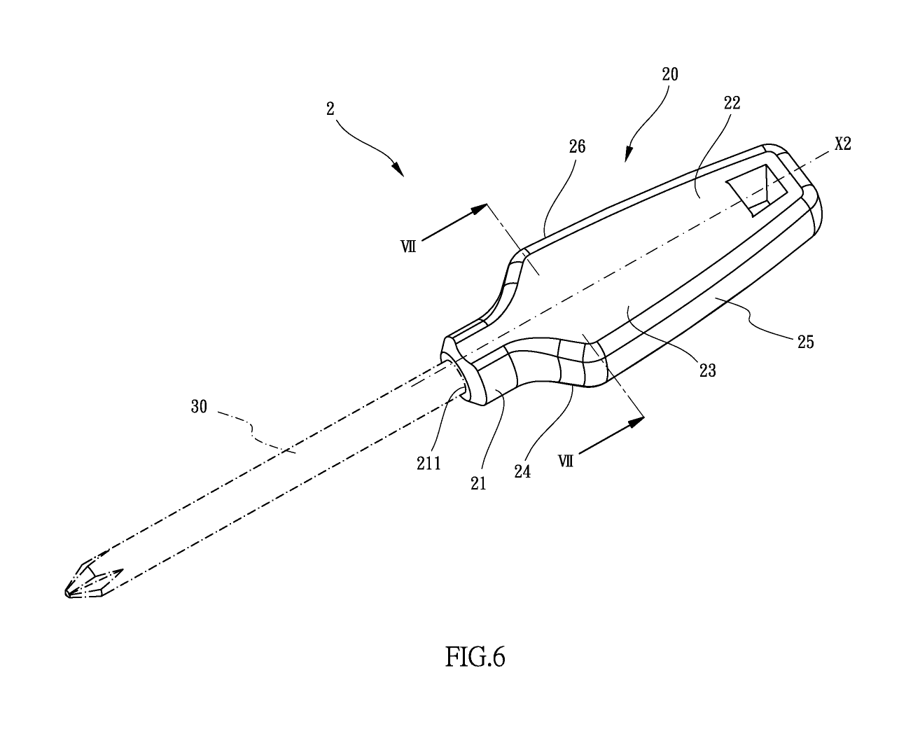

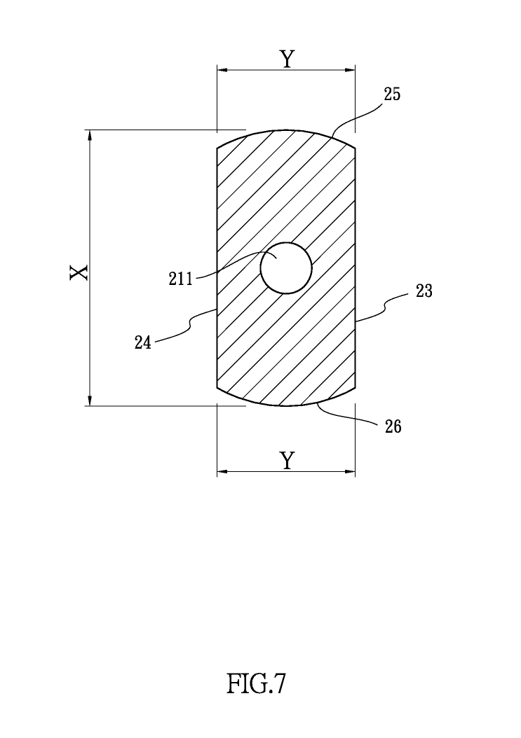

Referring to FIGS. 6 and 7, the handle 20 of a hand tool of the present invention comprises a connection portion 21 and a grip portion 22, wherein the grip portion 22 has two parallel side faces 23, 24. Each of the side faces 23, 24 has a width of X. Two protrusions 25, 26 are formed between the two side faces 23, 24. Each of the two protrusions 25, 26 has a width of Y, wherein Y≦¾X.

The connection portion 21 has a connection position 211 formed at the distal end thereof, and the connection position 211 is an oval hole in this embodiment, while other known arrangements can also be used. The connection position 211 is connected with a driving member 30 which is directly inserted in the connection position 211, or connected to the connection position 211 by way of plastic ejection molding. The axis of the handle 20 is parallel to the driving member 30. The connection position 211 has a long axis and a short axis, the length of the long axis Z, wherein Z≦½Y. The driving member 30 can be firmly connected to the connection portion 21 and is able to output sufficient torque.

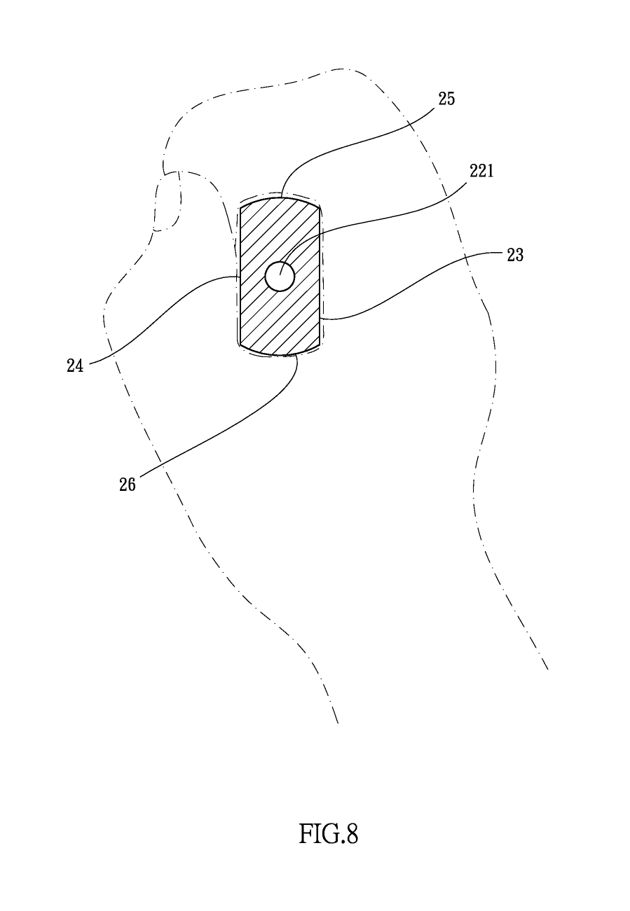

Thanks to the side faces 23, 24 of the handle 20, the handle 20 is compact and smaller than the conventional handle. Also, weight of the handle 20 of the present invention is reduced. Because the handle 20 has the two side faces 23, 24, the user can easily hold the grip portion 22 as shown in FIG. 8.

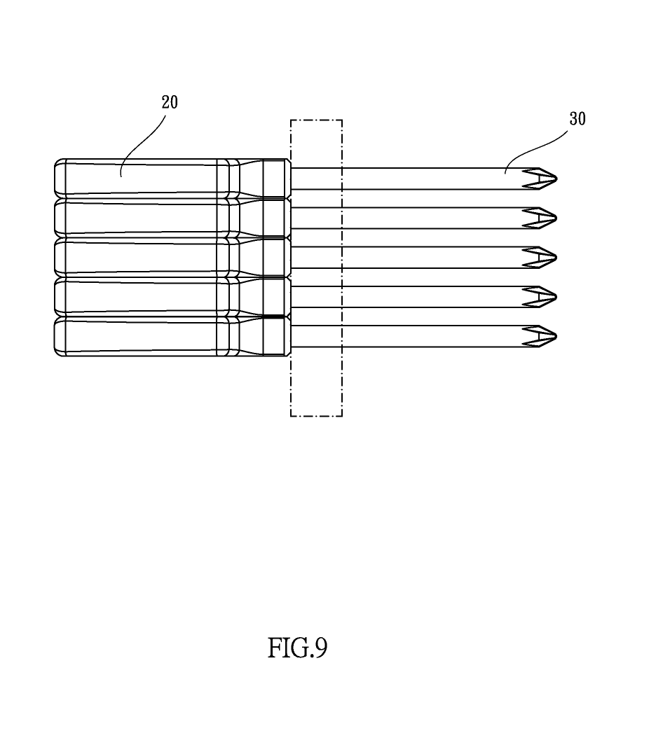

As shown in FIG. 9, when multiple handles 20 are stored in a limited space, the side faces 23, 24 allow the handles 10 to be organized side-by-side to save storage space.

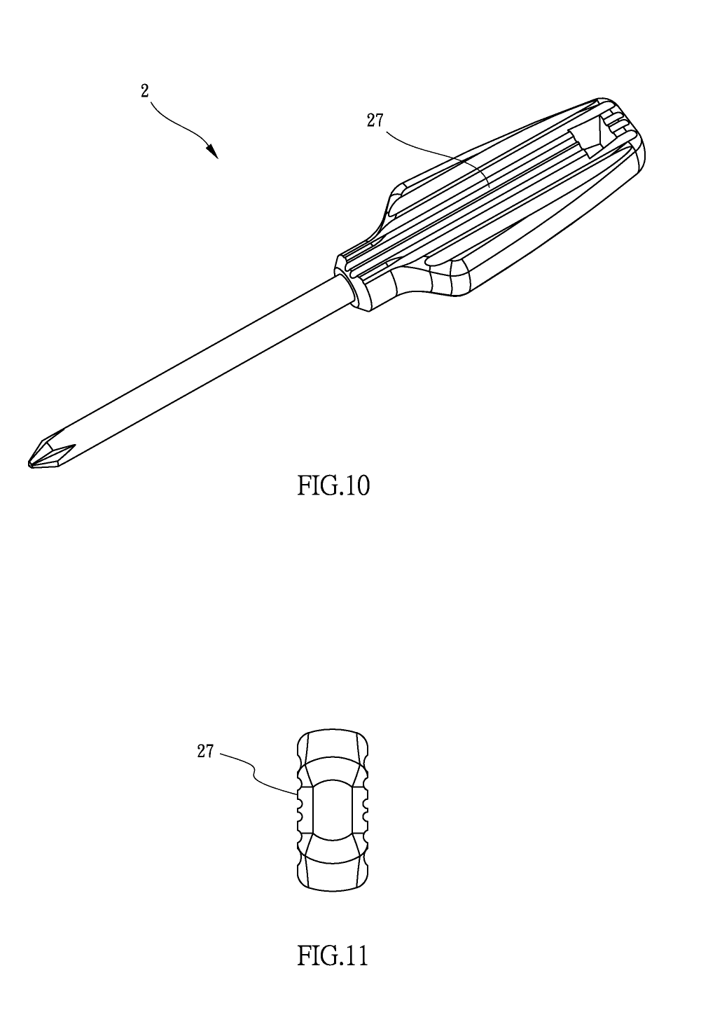

As shown in FIGS. 10 and 11, the grip portion 22 has an anti-slip portion 27 formed on the side faces 23, 24 to increase friction between the grip portion 22 and the user's hand.

While we have shown and described the embodiment in accordance with the present invention, it should be clear to those skilled in the art that further embodiments may be made without departing from the scope of the present invention.

What is claimed is:

1. A handle of a hand tool, comprising:
a handle having a connection portion and a grip portion, the grip portion having two parallel side faces, each of the side faces having a width of X, two protrusions formed between the two side faces, each of the two protrusions having a width of Y, Y≦¾X, the connection portion having a connection position formed at a distal end thereof, the connection position being adapted to be connected with a driving member, an axis of the handle being parallel to the driving member, the connection position having a long axis and a short axis, a length of the long axis Z, Z≦½Y.

2. The handle as claimed in claim 1, wherein the grip portion has an anti-slip portion formed thereon.
